(19) United States
(12) Patent Application Publication
(10) Pub. No.: US 2014/0280071 A1
(43) Pub. Date: Sep. 18, 2014

(54) SYSTEMS, METHODS AND APPARATUS FOR PROVIDING ACCESS TO ONLINE SEARCH RESULTS

(71) Applicants: Deven Scott NEMER, Thousand Oaks, CA (US); Gregory FRIEDMAN, Los Angeles, CA (US)

(72) Inventors: Deven Scott NEMER, Thousand Oaks, CA (US); Gregory FRIEDMAN, Los Angeles, CA (US)

(73) Assignee: NEVADA FUNDING GROUP INC., Las Vegas, NV (US)

(21) Appl. No.: 14/206,910

(22) Filed: Mar. 12, 2014

Related U.S. Application Data
(60) Provisional application No. 61/792,750, filed on Mar. 15, 2013.

(51) Int. Cl. G06F 17/30

(52) U.S. Cl. CPC G06F 17/30554
USPC 707/722

(57) ABSTRACT

A full-duplex communication channel is established between the server and a user device. A plurality of search results is obtained based on a request received from the user device. The plurality of search results is provided to the user device via the full-duplex communication channel. The user device is caused to display the plurality of search results in a first webview. A selection of a particular search result among the plurality of search results is received from the user device, via the full-duplex communication channel. Content associated with the particular search result is provided to the user device, via the full-duplex communication channel. The user device is caused to display simultaneously the plurality of search results in the first webview and the content in a second webview.

This application claims priority from U.S. Provisional Application No. 61/792,750, filed Mar. 15, 2013, which is hereby incorporated by reference herein in its entirety.

### TECHNICAL FIELD

This specification relates generally to systems and methods for managing online content, and more particularly to systems and methods for providing access to online search results.

### BACKGROUND

As the quantity of online content continually increases, there is a growing need for improved systems and methods for performing searches for content, and for presenting the results of search, in an efficient and user-friendly manner. Current systems and methods typically perform a search and present a plurality of search results, in summarized form, on a single web page displayed on a display device. When the user selects one of the search results, the content associated with the selected result is retrieved, and the page showing the search results is removed from the display device and replaced by a page displaying the desired content. If the user wishes to view the search results again, the user typically must select a “back” option, in response to the user's selection of the back option, the page showing the selected content is removed and the page showing the search results is again displayed.

### SUMMARY

In accordance with an embodiment, a method of providing information is provided. A plurality of search results is obtained based on a search performed in response to a. request received from a user device. The user device is caused to display the plurality of search results in a first region of a display, in response to selections of respective search results from among the plurality of search results, the user device is caused to display, simultaneously, the plurality of search results in a first region of a display and content associated with each selected search result in a second region of the display.

In one embodiment, a websocket connection, is established between a server and the user device. The plurality of search results are provided to the user device via the websocket connection.

In another embodiment, the plurality of search results are streamed to the user device via the websocket connection.

In accordance with another embodiment, a method of providing information via a network is provided. A full-duplex communication channel is established between the server and a user device. A plurality of search results is obtained based on a request received from the user device. The plurality of search results is provided to the user device via the full-duplex communication channel. The user device is caused to display the plurality of search results in a first webview. A selection of a particular search result among the plurality of search results is received from the user device, via the full-duplex communication channel. Content associated with the particular search result is provided to the user device, via the full-duplex communication channel. The user device is caused to display simultaneously the plurality of search results in the first webview and the content in a second webview.

In another embodiment, the full-duplex communication channel comprises a websocket connection.

In another embodiment, a WebSocket handshake request is received from the user device, and a WebSocket handshake response is transmitted to the user device.

In another embodiment, communications are conducted via the full-duplex communication channel using Transmission Control Protocol (TCP) port 80.

In another embodiment, providing the plurality of search results to the user device via the full-duplex communication channel further comprises streaming the plurality of search results to the user device via the full-duplex communication channel.

In another embodiment, a device crawls a network to identify a plurality of pages of content. For each respective page of content among the plurality of pages of content, the device indexes the respective page of content, and stores at least a portion of the content in a storage.

In another embodiment, as second selection. of a second particular search result among the plurality of search results is received from the user device, via the full-duplex communication channel. Second content associated with the second particular search result is provided to the user device, via the full-duplex communication channel. The user device is caused to display simultaneously the plurality of search results in the first webview and the second content in the second webview.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a network manager in accordance with an embodiment;

FIG. 3 shows a user login page in accordance with an embodiment;

FIG. 4 shows a network manager and a plurality of user devices connected by respective websocket connections;

FIG. 5 shows a menu page in accordance with an embodiment;

FIG. 6 shows a search page in accordance with an embodiment;

FIG. 7 is a flowchart of a method of providing search results to a user in accordance with an embodiment;

FIG. 8 shows a page displaying search results in accordance with an embodiment;

FIG. 9 shows a first webview displaying a plurality of search results and a second webview displaying content in accordance with an embodiment;

FIG. 10 shows a first webview displaying a plurality of search results and a second webview displaying content in accordance with an embodiment;

FIG. 11 shows a first webview displaying a plurality of search results and a second webview displaying content in accordance with an embodiment;

FIG. 12A is a flowchart of a method of providing search results and content in accordance with an embodiment;

FIG. 12B shows a web page in accordance with an embodiment; and

FIG. 13 is a high-level block diagram of an exemplary computer that may be used to implement certain embodiments.

### DETAILED DESCRIPTION

FIG. 1 shows a communication system in accordance with an embodiment. Communication system 100 comprises a network 105, a network manager 135, and a search service 155. Communication system 100 also includes a plurality of content servers 180-A, 180-B, 180-C, etc, Communication system 100 also comprises a plurality of user devices 160-A, 160-B, 160-C, etc.

For convenience, the term “user device 160” is sometimes used herein to refer to any one of user devices 160-A, 160-B, 160-C, etc. Accordingly, any discussion herein referring to “user device 160” is equally applicable to each of user devices 160-A, 160-B, 160-C, etc. Communication system 100 may include more or fewer than three user devices.

Similarly, the term “content server 180” is sometimes used herein to refer to any one of content servers 180-A, 180-B, 180-C, etc. Accordingly, any discussion herein referring to “content server 180” is equally applicable to each of content servers 180-A, 180-B, 180-C, etc. Communication system 100 may include more or fewer than duce content servers.

In the exemplary embodiment of FIG. 1, network 105 is the internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. In one embodiment, user device 160 rain include an Internet browser that enables a user to access content via the Internet. In one embodiment, user device 160 has a display screen for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

Content server 180 stores content that may be accessed via network 105. For example, content stored on a content server 180 may be provided to a user in the form of a web page, or in another format.

Search service 155 from time to time performs a search function (e.g., an Internet search function) based on information provided by a user. For example, search service 155 may comprise a search engine that obtains search results based on a keyword provided by a user. Search service 155 may comprise a publicly available search engine or a proprietary search engine.

In accordance with an embodiment, search service 155 performs a content indexing function to create and update the content stored in content servers 180. For example, search service may crawl network 105 to identify content, e.g., web pages and other content. For each respective page of content identified, search service 155 indexes the respective page of content, and stores at least a. portion of the content in a selected content server 180.

In one embodiment, a selected portion of content is retrieved from each page of content thus identified. For example, if search service 155 identifies a web page containing an article that includes text and images, and additionally contains advertisements, links to other websites, etc., only the text and images from the article are stored in content server 180, while the advertisements and links are not stored. In another embodiment, only title, metadata, and text in the body is stored and used to provide search result content and hill text indexing.

Network manager 135 controls access to content and services. FIG. 2 shows components of network manager 135 in accordance with an embodiment. Network manager 135 includes a controller 210, a user registration & login module 220, a websocket module 225, and a storage 230. Controller 210 orchestrates the operation of other components of network manager 135. User registration & login module 220 manages the registration and login of a user prior to the user being permitted to access content and services. Storage 230 is used from time to time by other components of network manager 135 to store various types of data. For example, in the illustrative embodiment of FIG. 2, a user registration database 265 containing usernames, passwords, and other information relating to various users is stored in storage 230. Network manager 135 may include other components not shown in FIG. 2.

Websocket module 225 from time to time establishes a websocket connection between network manager 135 and another device in communication system 100. As used herein, the term “websocket connection” refers to a connection established in accordance with the WebSocket protocol, which provides full-duplex communication channels over a single TCP connection. The WebSocket protocol was standardized by the IETF as RFC 6455 in 2011.

In another embodiment, a WebSocket API in Web IDL is used.

Communications conducted via a websocket connection are different from HTTP communications, because unlike HTTP, WebSocket provides for full-duplex communication. HTTP uses a request-response structure in which a client transmits a request to a server, and the server transmits a response after the complete request has been transmitted, in contrast, after an initial handshake, WebSocket does not require repeated requests and responses for each communication. Additionally, WebSocket enables streams of messages on to of TCP. Secure versions of the WebSocket protocol have been implemented for a variety of different browsers.

To establish as websocket connection, a client sends a WebSocket handshake request, in a well-known format, and the server sends a WebSocket handshake response, in a well-known format. The handshake resembles HTTP so that servers can handle HTTP connections as well as websocket connections on the same port. However, the specific fields involved, and activity after the handshake, do not conform to the HTTP protocol.

In one embodiment, websocket communications are conducted using Transmission Control Protocol (TCP) port 80.

Once a websocket connection is established, the client and server can send WebSocket data or text frames hack and forth in full-duplex mode. The data is minimally framed, with as small header followed by payload. WebSocket transmissions are described as “messages,” where a single message can optionally be split across several data frames. This allows for sending of messages where initial data is available but the complete length of the message is unknown.

In one embodiment, network manager 135 manages communications between a user device 160 and another component of communication system 100. For example, as request for data sent by user device 160-A to search service 155 is transmitted via websocket connection 410 to network manager 135, which forwards the request to search service 155. Data transmitted by search service 155 to user device 160-A in response to the request is transmitted to network manager 135 and then to user device 160-A via websocket connection 410. Content provided by a content server 180 may also be provided to network manager 135 and then to user device 160-A via websocket connection 410.

In an illustrative embodiment, a user employing user device 160-A accesses a website maintained by network manager 135. For example, the user may utilize a browser application (not shown) residing and operating on user device 160-A to access the website. Upon accessing the website, user registration & login module 220 (of network manager 135) may provide a user login page such as that shown in FIG. 3. User login page 300 includes a username field 310 and a password field 320. After the user enters a valid username and password, and is authenticated, controller 210 of network manager 135) instructs websocket module 225 to establish a websocket connection between network manager 135 and user device 160-A. In response, websocket module 225 establishes a websocket connection between network manager 135 and user device 160-A. Referring to FIG. 4, a websocket connection 410 is established between network manager 135 and user device 160-A.

In one embodiment, network manager 135 is capable of establishing and maintaining a plurality of separate websocket connections simultaneously between network manager 135 and a plurality of user devices. FIG. 4 shows network manager 135 and a plurality of user devices 160-A, 160-B, and 160-C. While websocket connection 410 is maintained between network manager 135 and user device 160-A, a second websocket connection 420 is established between network manager 135 and user device 160-B, and a third websocket connection 430 is established between network manager 135 and user device 160-C.

After websocket connection 410 is established between network manager 135 and user device 160-A, controller 210 (of network manager 135) causes the browser on user device 160-A to display a menu page such as that shown in FIG. 5 that indicates one or more products and/or services available via the website. Menu page 500 presents a plurality of selections including a search button 510, a games button 520, a chat button 530, a store button 540, a music button 550, and an email button 560. Other selections may be included.

In the illustrative embodiment, the user of user device 160-A wishes to perform a search related to a particular topic of interest. Accordingly, the user selects search button 510. Network manager 135 transmits the user's request to search service 155. Search service 155 causes user device 160-A to display a search page such as that shown in FIG. 6. Search page 600 comprises a keyword field 503 and a search button 606. The user enters a keyword, “Keyword-1,” in field 603, as shown in FIG. 6, and selects search button 606. Search service 155 receives the specified keyword.

While in the illustrative embodiment, components of communication system 100 from time to time provide web pages which a user may view and employ to enter information, in other embodiments, other interfaces may be used to communicate with a user. For example, in another embodiment, one or more pages associated with a mobile App may be used.

In accordance with an embodiment, search results are obtained and displayed in a first webview on user device. When the user selects a particular one of the search results, content associated with the selected result is displayed on user device 160-A in a second webview. FIG. 7 is a flowchart of a method of providing search results to a user in accordance with an embodiment. At step 710, a full-duplex communication channel is established between a server and a user device. In the illustrative embodiment discussed above, websocket module 225 establishes websocket connection 410 between network manager 135 and user device 160-A.

At step 720, a plurality of search results arc obtained based on a request received from the user device. Search service 155 receives the user's request for a search and the keyword provided by the user, and performs a search. For example, search service 155 may search content stored in content servers 180 to find content satisfying the user's request. Search service 155 generates a plurality of search results and provides the search results to network manager 135.

At step 730, the plurality of search results are provided to the user device via the full-duplex communication channel. Network manager 135 provides the search results to user device 160-A via websocket connection 410.

At step 740, the user device is caused to display the plurality of search results in a first webview. Referring to FIG. 8, network manager 135 causes user device 160-A to display, on a display device, a first webview 800 showing the search results including Result1 (810), Result2 (820), Result3 (830), Result4 (840), etc. In the illustrative embodiment, webview 800 comprises a web page; however, in other embodiments, a webview may have another form or format. As indicated in FIG. 8, a summarized form of the content associated with each result is displayed on webview 800. Thus, for example, a summarized form of the content associated with Result1 (810) is displayed, a summarized form of the content associated with Result2 (820) is displayed, etc. A scroll bar 890 is provided on the side of webview 800; the user may employ scroll bar 890 to scroll down the page to view additional search results.

At step 750, a selection of a particular search result among the plurality of search results is received from the user device, via the full-duplex communication channel. Supposing that the user peruses the various results shown in FIG. 8, and decides that he or she wishes to view Result3 (830) in further detail, the user then selects Result3 (830) by, for example, using a computer mouse to cause a cursor (not shown) to hover over Result3 (830) and then doubling-clicking. The user's selection is transmitted by user device 160-A to network manager 135 via websocket connection 410.

At step 760, content associated with the particular search result is provided to the user device, via the full-duplex communication channel. Network manager 135 retrieves content associated with Result3 (830) from the appropriate content server 180. Network manager 135 may retrieve only the main content, including text, images, etc.; the main content does not contain advertisements, for example. Network manager 135 transmits the content to user device 160-A via websocket connection 410.

At step 770, the user device is caused to display simultaneously the plurality of search results in the first webview and the content in a second webview. In response to the user's selection of Result3 (830), network manager 135 causes user device 160-A to shift webview 800 (including search results 810, 820, 830, 840, and scroll bar 890) to a first region located on the left-hand side of the display, as shown in FIG. 9. Network manager 135 also causes user device 150-A to open a second webview 900 in a second region located in the center and right-hand side of the display. Network manager 135 causes user device 160-A to display the content associated with Result3 (830) in webview 900. In the illustrative embodiment, webview 900 is a web page. A second scroll bar 990 for scrolling through the content of Result3 (830) is displayed on the right-hand side of webview 900.

After reviewing, the content of Result3 (830) shown in webview 900, the user now wishes again to examine the search results to view another search result. Accordingly, the user employs scroll bar 890 (in webview 800) to scroll down through the search results and views other search results, as shown in FIG. 10. Specifically, Result18 (1018) Result19 (1019), Result20 (1020), and Result 21 (1021) are now displayed in webview 800. User device 160-A continues to display webview 900 containing the content of Result3 (830). Communications between user device 160-A and network manager 135 are conducted via websocket connection 410.

The user, wishing to view the content of Result19 (1019), selects Result19 (1019) within webview 800. User device 160-A transmits the user's selection to network manager 135 via websocket connection 410. In response to the user's selection, network manager 135 retrieves the content associated with Result19 (1019) from the appropriate content server 180, and transmits the content to user device 160-A via websocket connection 410. Network manager 135 causes user device 160-A to display the content of Result19 (1019) in a webview 1100, in the region located in the center and right-hand side of the display, as shown in FIG. 11. A scrollbar 1190 is provided on the side of webview 1100. Webview 100 and webview 800 are displayed simultaneously on the display. The user may now review the contents of Result19 (1019) in detail.

In one embodiment, search results, and the content associated with a selected search result, are streamed by network manager 135 to user device 160-A via websocket connection 410.

Advantageously, a user may quickly obtain and view (e.g., in webview 900, 1100) the content associated with different search results listed in webvievv 800 by selecting the respective results. Because network manager 135 maintains a websocket connection with user device 160-A, the content associated with a selected search result is transmitted to user device 160-A without the need, for example, to complete a request-response procedure as required by the HTTL protocol each time a different result is selected.

While in certain embodiments, data is transmitted via a websocket connection, in other embodiments, a websocket connection is not used to transmit information to user device 160. Certain systems and methods described herein may be implemented using a websocket connection only for selected transmissions while using other communication channels and protocols for other transmissions. Likewise, certain systems and methods described herein may be implemented without the use of a websocket connection.

FIG. 12A is a flowchart of a method of displaying search results and content in accordance with an embodiment. At step 1210, a plurality of search results is obtained based on a search performed in response to a request received from a user device. At step 1220 the user device is caused to display the plurality of search results in a first region of a display. In one embodiment, all or a portion of the search results are transmitted to the user device via a websocket connection. In other embodiments, all or a portion of the search results are transmitted to the user device via network 105 using other communication channels and protocols, such as HTTP (without using a websocket connection). In some embodiments, search results are initially provided to user device 160 via network 105 using HTTP protocol-based communication, and subsequent updates are transmitted to user device 160 via a websocket connection. At step 1230, in response to selections of respective search results from among the plurality of search results, the user device is caused to display, simultaneously, the plurality of search results in a first region of a display and content associated with each selected search result in a second region of the display.

In another embodiment, user device 160 transmits to network manager 135 a copy of the extracted (or “scraped”) page content in combination with meta data such as how long the page took to load, did the user bounce (immediately leave the page) did they stay on for a reasonable amount of time that would show that they read or otherwise consumed the content of the page, along with other metrics that could be valuable in showing how members interact with the content and the likely opinions they have of the content. Network manager 135 stores such information.

In another embodiment, the user is able to click the name and/or logo of another company and the keyword that the user previously entered can be automatically searched via the search engine the user wanted to use, without the user having to re-type the keywords. A list of search engines is shown in a first webview, while the search engine results are shown in a second webview. FIG. 12B shows a page 1260 comprising a first webview 1262 and a second webview 1264. First webview 1262 includes list 1268 of search engines accessible via the Internet. Webview 1264 includes a first region 1271 showing various search results from the world wide web, a second region 1273 showing search results that comprise, photographs, and a third region showing search results that comprise videos. Information 1285 comprising content extracted, statistics/reports, page load times, data indicating whether the user bounced, and time spent on a web page, may be transmitted to network manager 135.

In various embodiments, the method steps described herein, including the method steps described in FIG. 7 and/or 12, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network based cloud computing system. In such a network-based cloud computing system, a server or another processor that is connected to a network communicates with one or more client computers via a network. A client computer may communicate with the server is a network browser application residing and operating on the client computer, for example. A client computer may store data on the server and access the data via the network. A client computer may transmit requests for data or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may he implemented using a computer program product tangibly embodied in an information carrier, e.g., in a non-transitory machine-readable storage device, for execution by a programmable processor, and the method steps described herein, including one or more of the steps of FIG. 7 and/or 12, may be implemented using one or more computer programs that are executable by such a processor. A computer program is a set of computer program instructions that can be used, directly or indirectly, in a computer to perform a certain activity or bring out a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 13. Computer 1300 includes a processor 1301 operatively coupled to a data storage device 1302 and a memory 1303. Processor 1301 controls the overall operation of computer 1300 by executing computer program instructions that define such operations. The computer program instructions may be stored in data storage device 1302, or other computer readable medium, and loaded into memory 1303 when execution of the computer program instructions is desired. Thus, the method steps of FIG. 7 and/or 12 can be defined by the computer program instructions stored in memory 1303 and/or data storage device 1302 and controlled by the processor 1301 executing the computer program instructions. For example, the computer program instructions can be implemented as computer executable code programmed by one skilled in the art to perform an algorithm defined by the method steps of FIG. 7 and/or 12. Accordingly, by executing the computer program instructions, the processor 1301 executes an algorithm defined by the method steps of FIG. 7 and/or 12. Computer 1300 also includes one or more network interfaces 1304 for communicating with other devices via a network. Computer 1300 also includes one or more input/output devices 1305 that enable user interaction with computer 1300 e.g., display, keyboard, mouse, speakers, buttons, etc,).

Processor 1301 may include both general and special purpose microprocessors, and may be the sole processor or one of multiple processors of computer 1300. Processor 1301 may include one or more central processing units (CPUs), for example. Processor 1301, data storage device 1302, and/or memory 1303 may include, be supplemented by, or incorporated in, one or more application-specific integrated circuits (ASICs) and/or one or more field programmable gate arrays (FPGAs).

Data storage device 1302 and memory 1303 each include a tangible non-transitory computer readable storage medium. Data storage device 1302, and memory 1303, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM) digital versatile disc read-only memory (DVD-ROM) disks, or other non-volatile solid state storage devices.

Input/output devices 1305 may include peripherals, such as a printer, scanner, display screen, etc. For example, input/output devices 1305 may include a display device such as a cathode ray tube (CRT) or liquid crystal display (LCD) monitor for displaying information to the user, a keyboard, and a pointing device such as a mouse or a trackball by which the user can provide input to computer 1300.

Any or all of the systems and apparatus discussed herein, including network manager 135, content server 180, search service 155, and user device 160, and components thereof, including controller 210, user registration & login module 220, websocket module 225, and storage 230, may be implemented using a computer such as computer 1300.

One skilled in the art will recognize that an implementation of an actual computer or computer system may have other structures and may contain other components as well, and that FIG. 13 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative, of the principles of the present invention and that various modifications may be implemented by those skilled in the art without departing from the scope and spirit of the invention. Those skilled in the art could implement various other feature combinations without departing from the scope and spirit of the invention.

1. A method of providing information, the method comprising:
obtaining a plurality of search results based on a search performed in response to a request received from a user device;
causing the user device to display the plurality of search results in a first region of a display;
in response to selections of respective search results from among the plurality of search results, causing the user device to display, simultaneously, the plurality of search results in a first region of a display and content associated with each selected search result in a second region of the display.

2. The method of claim 1, further comprising:
establishing, by a server, websocket connection between the server and the user device; and
providing the plurality of search results to the user device via the websocket connection.

3. The method of claim 2, further comprising:
streaming the plurality of search results to the user device via the websocket connection.

4. A method of providing information via a network, the method comprising:
establishing, by a server, a full-duplex communication channel between the server and a user device;
obtaining a plurality of search results based on a request received from the user device;
providing the plurality of search results to the user device via the full-duplex communication channel;
causing the user device to display the plurality of search results in a first webview;
receiving from the user device, via the full-duplex communication channel, a selection of a particular search result among the plurality of search results;
providing to the user device, via the full-duplex communication channel, content associated with the particular search result; and
causing the user device to display simultaneously the plurality of search results in the first webview and the content in a second webview.

5. The method of claim 4, wherein the full-duplex communication channel comprises a websocket connection.

6. The method of claim 5, further comprising:
receiving a WebSocket handshake request from the user device; and
transmitting to the user device a WebSocket handshake response.

7. The method of claim 6, wherein communications are conducted via the full-duplex communication channel using Transmission Control Protocol (TCP) port 80.

8. The method of claim 4, wherein providing the plurality of search results to the user device via the full-duplex communication channel further comprises:
streaming the plurality of search results to the user device via the full-duplex communication channel.

9. The method of claim 4, further comprising:
crawling a network to identify a plurality of pages of content;
for each respective page of content among the plurality of pages of content:
indexing the respective page of content; and
storing at least a portion of the content in a storage.

10. The method of claim 4, further comprising:
receiving from the use device, via the full-duplex communication channel, a second selection of a second particular search result among the plurality of search results;
providing to the user device, via the full-duplex communication channel, second content associated with the second particular search result; and
causing the user device to display simultaneously the plurality of search results in the first webview and the second content in the second webview.

11. A system comprising:
a storage adapted to store one or more search results;
a processor adapted to:
establish a full-duplex communication channel between the server and a user device;
obtain a plurality of search results based on a request received from the user device;
provide the plurality of search results to the user device via the full-duplex communication channel;
cause the user device to display the plurality of search results in a first webview;
receive from the user device, via the full-duplex communication channel, a selection of a particular search result among the plurality of search results;
provide to the user device, via the full-duplex communication channel, content associated with the particular search result; and
cause the user device to display simultaneously the plurality of search results in the first webview and the content in a second webview.

12. The system of claim 11, wherein the full-duplex communication channel comprises a websocket connection.

13. The system of claim 12, wherein the processor is further adapted to:
receive a WebSocket handshake request from the user device; and
transmit to the user device a WebSocket handshake response.

14. The system of claim 13, wherein communications are conducted via the full-duplex communication channel using Transmission Control Protocol (TCP) port 80.

15. The system of claim 11, wherein the processor is further adapted to:
stream the plurality of search results to the user device via the full-duplex communication channel.

16. The system of claim 11, wherein the processor is further adapted to:
crawl a network to identify a plurality of pages of content;
for each respective page of content among the plurality of pages of content:
index the respective page of content; and
store at least a portion of the content in a storage.

17. The system of claim 11, wherein the processor is further adapted to:
receive from the user device, via the full-duplex communication channel, a second selection of a second particular search result among the plurality of search results;
provide to the user device, via the full-duplex communication channel, second content associated with the second particular search result; and
cause the user device to display simultaneously the plurality of search results in the first webview and the second content in the second webview.
